(19) United States
(12) Patent Application Publication
(10) Pub. No.: US 2010/0187829 A1
(43) Pub. Date: Jul. 29, 2010

(54) FLUID FLOW ENERGY HARVESTER

(75) Inventor: Joel S. Douglas, Groton, CT (US)

Correspondence Address: MICHAUD-Kinney Group LLP, 306 INDUSTRIAL PARK ROAD, SUITE 206, MIDDLETOWN, CT, 06457, US

(73) Assignee: EGEN LLC, Groton, CT (US)

(21) Appl. No.: 12/691,951

(22) Filed: Jan. 22, 2010

Related U.S. Application Data
(60) Provisional application No. 61/206,044, filed on Jan. 26, 2009.

(51) Int. Cl. F03D 9/02; F03B 13/08; F03G 7/10

(52) U.S. Cl. 290/55; 290/54; 74/DIG. 9

(57) ABSTRACT

An energy harvester capable of providing motion from fluid flow includes a Magnus cylinder defined by a cylinder driven by a motor causing the cylinder to rotate so that lift is created by the fluid flowing past the cylinder. A channel or system may be provided to direct the fluid flow to the cylinder. The rotating cylinder configuration is integrated into a mechanical device that is designed to transfer the lift into a rotary mechanical motion to drive a generator. The device can be utilized in either air or hydraulic environments. A modification of the energy harvester can be configured to utilize the electricity generate to produce hydrogen for use in fuel cells or for combustion.

### CROSS REFERENCE TO RELATED APPLICATIONS

This application claims the benefit of U.S. Provisional Patent Application No. 61/206,044 filed Jan. 26, 2009, contents of the foregoing application being incorporated herein by reference in their entirety.

### TECHNICAL FIELD

This invention relates to a device for harvesting energy and more specifically to an energy harvester that extracts energy from fluid flow by exploiting the lift created by the flow as it passes a rotating cylinder. The device can be used with hydro-pneumatic, hydro, wind, or wave power systems.

### BACKGROUND

Hydropower systems are used for generating power from the tidal or current motion of water in oceans, bays, and rivers. Typically, such systems employ a high water head and high water flow conditions. System operating parameters that include both a high water head and high flow conditions limit the suitable sites for locating fluid flow energy harvesters. Conventional hydro turbine technology, which involves positioning a powerhouse in a dam body with turbines located below the lowest water level, has been applied at mountain river and waterfall sites where a large water head can be developed. Consequently, powerhouses using hydro turbines are generally installed in large and complicated dam structures capable of withstanding the enormous water pressures generated. On the other hand, the hydro energy potential of thousands of rivers, streams, and canals remain untapped because hydro turbines, as an economical and practical matter, do not operate effectively with a low water head, in other words, when water level differences are about three meters or less. Such conventional hydro turbines need significant water depth for installation and cost-efficient operation.

Systems have also been developed to generate power using lower water head. These systems are described in U.S. Pat. Nos. 4,717,832, 5,074,710, and 5,222,833, the disclosures of which are incorporated herein by reference.

Systems for utilizing tidal motion and current flow of oceans and rivers are also known. Such systems usually require a dam or other physical structure that separates one part of a water body from another part. A difference in water levels is thereby created which provides a pressure differential useful for driving mechanical devices such as hydro turbine generators.

Also, axial-flow turbine type devices deriving power from liquid flow in tidal runs and streambeds are known. Such devices are disclosed in U.S. Pat. No. 3,980,894 to P. Vary et al., U.S. Pat. No. 3,986,787 to W. J. Mouton, Jr., U.S. Pat. No. 4,384,212 to J. M. Lapeyre, U.S. Pat. No. 4,412,417 to D. Dementhon, and U.S. Pat. No. 4,443,708 to J. M. Lapeyre.

Pivotal flow-modifying means is shown in the above Mouton, Jr. patent in a multiple unit embodiment.

U.S. Pat. No. 4,465,941 to E. M. Wilson discloses a water-wheel type device for the purpose of flow control pivotal valves or deflectors.

Additionally, various Magnus effect generating systems have been envisioned. The Magnus effect was first publicized by Professor G. Magnus in 1853. The Magnus effect is a physical phenomenon in which a spinning object creates a current of rotating fluid about itself. As the current passes over the object, the separation of the turbulent boundary layer of flow is delayed on the side of the object that moves in the direction of the fluid flow and is advanced on the side of the object that moves counter to the direction of the fluid flow. Thus, pressure is exerted in the direction of the side of the object that moves in the same direction of the fluid flow to provide movement substantially perpendicular to the direction of fluid flow. Briefly stated, when a rotating cylinder encounters a fluid flow at an angle to its rotational axis, a lifting force (lift) is created perpendicular to the flow direction. If a rotating cylinder is mounted on a vertical axis, the lift is developed at right angles to the direction of water flowing past the cylinder, left or right depending upon the direction of rotation.

The use of the Magnus effect can also be used to describe, among other things, the curved pitches of baseball and the shooting of airplane guns transversely to the airplane's path of travel.

Various patents disclose the use of the Magnus effect for airplane lift, steering a boat, and for assisting in submarine steering.

The Magnus effect is utilized in U.S. Pat. No. 4,446,379 to Borg et al., which discloses Magnus cylinders mounted for rotation at right angles to shafts that are revolved about a generally vertical axis. The shafts are free to rotate 180 degrees. The Magnus cylinders are continuously rotated in the same angular direction. At one position of revolution of the shafts, the cylinders rotate on an axis generally parallel to the axis of revolution of the shafts. When the apparatus is immersed in a fluid flow (gaseous or liquid) a torque of rotation is developed when the shafts are aligned with the fluid flow, and this torque of rotation is reduced as the shaft approaches a position transverse to the fluid flow. As the shafts pass this transverse position, a torque is developed by the rotating cylinder that rotates the shafts 180 degrees at which point the formerly downwardly depending cylinder is now upright and the formerly upright cylinder is now downwardly depending on its shaft. The device was designed to utilize two or more shafts to which cylinders are attached, and there is continuous production of torque about the axis of revolution of the shafts. The complexity of this device makes it a difficult device to build or operate. If the Magnus effect is to be used to generate power, a simpler device is needed.

U.S. Pat. No. 4,582,013 to Holland describes a self-adjusting wind power machine that uses a cylinder.

Co pending U.S. Patent application 20090058091 entitled “Magnus Force Fluid Energy Harvester,” the disclosure of which is incorporated by reference herein in its entirety, describes an energy harvester capable of providing motion from fluid flow. The energy harvester includes a Magnus cylinder defined by a cylinder driven by a motor causing the cylinder to rotate so that lift is created by the fluid flowing past the cylinder. A channel or system may be provided to direct the fluid flow to the cylinder. The rotating cylinder configuration is integrated into a mechanical device that is designed to transfer the lift into a mechanical motion to drive a generator. The mechanical motion due to the created lift is reversed by using a stalling mechanism and counter balanced mechanism. This creates a bi-directional motion that can be captured and used to drive a generator. The device can be utilized in either air or hydraulic environments. A modification of the energy harvester can be configured to utilize the electricity generated to produce hydrogen for use in fuel cells or for combustion.

Pneumatically driven systems using turbine blades have also been developed. However, these systems normally use blades that rotate at high speeds. These rotating blades are problematic as any sizable foreign object encountered by the system can damage the blades, thereby compromising the structural integrity of the system. When the system utilizes the flow of air such as in the use of turbine blade aircraft, bird strikes can cause significant damage to the rotating blades, as can stones or other debris inadvertently or intentionally injected into the rotating blades. When the system is a water system, the injection of aquatic plants and animals as well as debris frequently found in waterways (e.g., chunks of wood) can also cause damage.

The majority of the systems envisioned by the aforementioned technologies utilize rotating blades that are noisy, detrimental to both flora and fauna, and require dams that interfere with the motion of the flowing water. Additionally, the systems that are utilized in these applications significantly obstruct sunlight, thereby detrimentally affecting aquatic plant life. These approaches are normally resisted by the affected communities due to the harm caused to flora and fauna and the damming of the body of water that negatively affects community activities. Damming and rerouting water flow can also cause significant upstream destruction of wildlife habitats.

Low head and low flow hydraulic conditions are prevalent throughout the world. The difficulty described therein is that there are no simple and easy methods to harness the energy from low head water sources to create power.

However, despite the technological efforts described previously there is no known system capable of generating electricity from low head/high power and low power sources such as tidal and/or river flow and being capable of continuous generation under changing flow conditions.

Given the increasing demand for industrial electricity in view of the issues related to the current state of the art of fluid flow energy harvesters, a need exists for a system that does not harm flora or fauna and can be introduced into the environment without interfering with the natural water flow or blocking the majority of the sunlight to the bottom of the body of water. A need also exists for an environmentally friendly, quiet, efficient, and simple energy harvester that can operate in low head and low flow conditions.

### SUMMARY OF THE INVENTION

As used herein, the term “hydro application” and “hydraulic” are used to describe the use of the energy harvesting device with regard to liquid, and the term “gas application” and “pneumatic” are used to describe the use of the energy harvesting device with regard to gas (e.g., air).

As used herein, the term “lift” refers to a force that is perpendicular to a direction of fluid flow.

As used herein, the term “electrical grid” refers to any system used to utilize or transport electrical current.

The present invention provides an energy harvesting device (or energy harvester) capable of generating energy from low power hydraulic or pneumatic flows using lift generated by the Magnus effect by taking advantage of the availability of sources of fluid flowing under low head pressure and/or flows of velocities of 1 feet per second or greater. The energy harvester comprises inflow and outflow fluid channels, an energy harvester chamber, and a series of revolving cylinders, which is typically mounted in a radial configuration and transversely to the direction of fluid flow. The inflow channel is provided with diverters and baffles to direct the flow of fluid to the cylinders.

The lift can be transferred into a mechanical system, for example, it can be transferred to a generator via a driveshaft or a similar mechanism.

For gas applications, the energy harvester applications are under ultra low head pressure fluid flow, and the energy harvester can readily deliver significant lift causing the system to drive a conventional industrial generator. This allows the energy harvester of the present invention to achieve efficiencies higher than energy harvesters of the prior art. For hydro applications, the energy harvester applications are under ultra low head flow or any strong current of 1 foot per second or greater, which is less than needed for prior art energy harvesters. Because radial hydro cylinders or air cylinders are used in the present applications, a highly scaleable application is achieved due to the energy required to develop lift and the lift developed being very large and having the ability to be focused at the central shaft.

In the case of pneumatic energy conversion, the channel forces the air to be directed at the air cylinder and delivers it so maximum lift is created. The energy captured in the flowing air is then converted to mechanical energy. Connection of the energy harvester to an electric generator allows for the generation of electrical energy. Increasing the speed of the air energy harvester to the generator's speed can be accomplished without additional gearing.

In a hydro application embodiment, the energy harvester can be mounted in a self-floating configuration and is attached to a vessel or platform located in a current of 1 foot per second or greater, such as in a tidal channel. In such an embodiment, the energy harvester is located just below the surface of the water, where the current velocity is greatest, and is retained in that location by virtue of the rise and fall of the vessel with the water. The rotary energy harvester embodiment is uniquely suited for this application. A housing to channel the flow to the energy harvester may by provided if desired, but is not necessary if the current velocity is sufficiently great. The energy harvester is connected to a suitable electric generator, which may be mounted on the vessel in a water tight chamber or which may be remotely located. Since the energy harvester is located in the water, the lift is converted into mechanical energy to drive the generator.

Alternatively the flow can be concentrated so that the speed of the fluid passing the air or hydraulic cylinders is accelerated to increase the lift of the cylinder. Channeling the flow from a larger cross section into a smaller cross section where the cylinder can take advantage of the increased flow speed of the fluid facilitates an increase in the lift of the cylinder.

Methods herein utilize the air or hydraulic cylinders to produce a rotating motion to directly drive a rotating generator. This would use a series of cylinders arranged in a wheel format and either a single motor or a series of motors to drive the cylinders. The cylinders are longitudinally separated in pairs so that flow from the first or leading cylinder is accelerated and further accelerated by the second or next cylinder which is in the rear of the first cylinder and positioned at least 30 degrees out of phase but not more than 179 degrees out of phase of the first cylinder. This positioning allows the fluid to be accelerated down the longitudinal length of the machine and accelerated by each cylinder thereby increasing the torque created by the lift of each cylinder, the lift being used to drive the rotating generator. The present invention is not limited with regard to the number of cylinder pairs that can be installed, however, as any number of cylinder pairs can be installed to generate the desired torque.

### BRIEF DESCRIPTION OF THE DRAWINGS

The invention will be more fully understood from the following detailed description taken in conjunction with the accompanying drawings in which:

FIG. 1 is a schematic side view representation of a radial device with staggered rotating Magnus cylinders in an axial position within a channel defined by walls;

FIG. 2 is a schematic end view representation of a radial device with staggered rotating Magnus cylinders in an axial position within a channel defined by walls;

FIG. 3 is a schematic top view representation of a radial device with staggered rotating Magnus cylinders in an axial position within a channel defined by walls;

FIG. 4 is a schematic side representation of a radial device with staggered rotating Magnus cylinders in an axial position within a tube;

FIG. 5 is a schematic end representation of a radial device with staggered rotating Magnus cylinders in an axial position within a tube;

FIG. 6 is a schematic representation of a double concentric shaft used to drive the Magnus cylinders and transmit the power to the generator;

FIG. 7 is a graphical representation of the torque vs. RPM for a flow of 2 feet per second for a machine schematically shown in FIGS. 4 and 5;

FIG. 8 is a graphical representation of the torque vs. RPM for a flow of 4 feet per second for a machine schematically shown in FIGS. 4 and 5;

FIG. 9 is a schematic representation of the Magnus cylinder force diagram;\

FIG. 10 is a schematic side representation of a radial device with planar rotating Magnus cylinders in an axial position within a tube;

FIG. 11 is a schematic end representation of a radial device with planar rotating Magnus cylinders in an axial position within a tube;

FIG. 12 is a schematic side representation of a radial device with double planar rotating Magnus cylinders in an axial position within a tube;

FIG. 13 is a schematic end representation of a radial device with double planar rotating Magnus cylinders in an axial position within a tube;

FIG. 14 is a schematic representation of a double concentric shaft used to drive the Magnus cylinders and transmit the power to the generator which then creates Hydrogen and oxygen;

FIG. 15 is a schematic representation of an energy harvester of the invention floating on a barge structure;

FIG. 16 is a schematic representation of an energy harvester of the invention attached to a bridge structure;

FIG. 17 is a schematic representation of an energy harvester of the invention attached to the bottom of the fluid channel by a bridge structure; and

FIG. 18 is a schematic representation of an energy harvester using a gear train and drive shaft system.

FIG. 19 is a schematic representation of an energy harvester incorporating a pinion gear to drive a generator.

FIG. 20 is a schematic representation of an energy harvester incorporating a pinion gear to drive a pump.

### DETAILED DESCRIPTION OF THE PREFERRED EMBODIMENTS

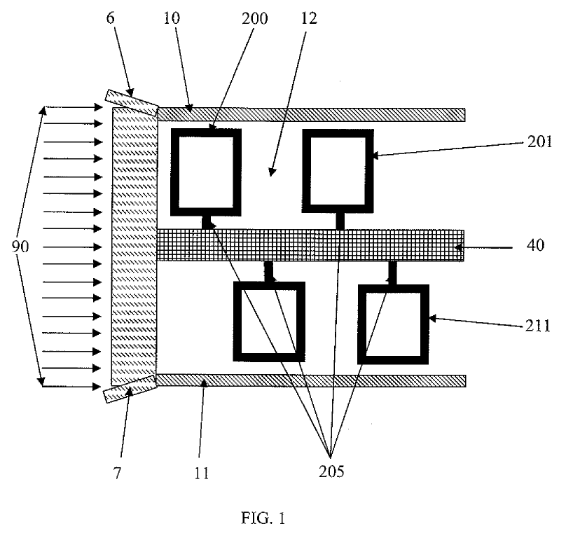

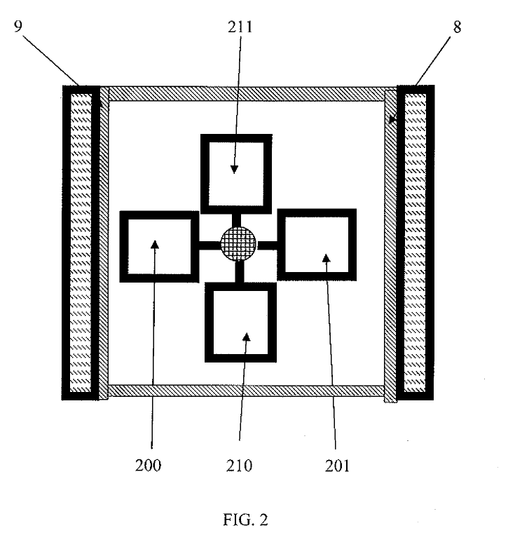

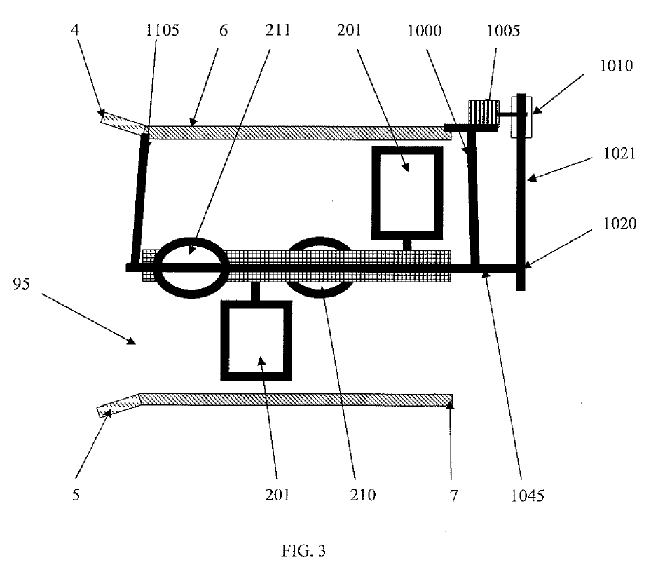

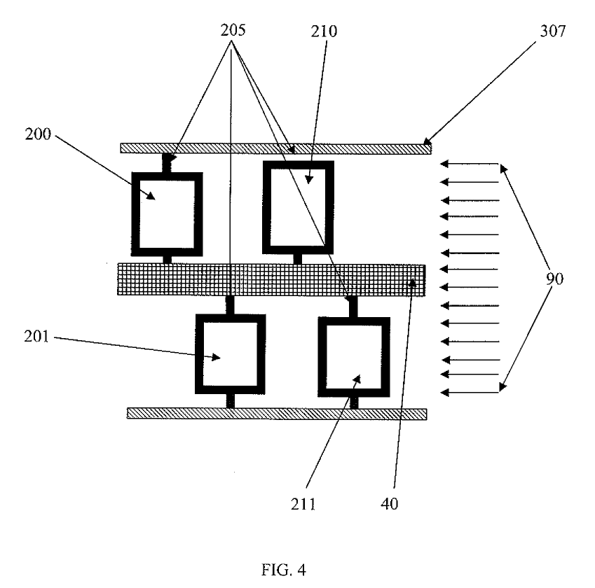

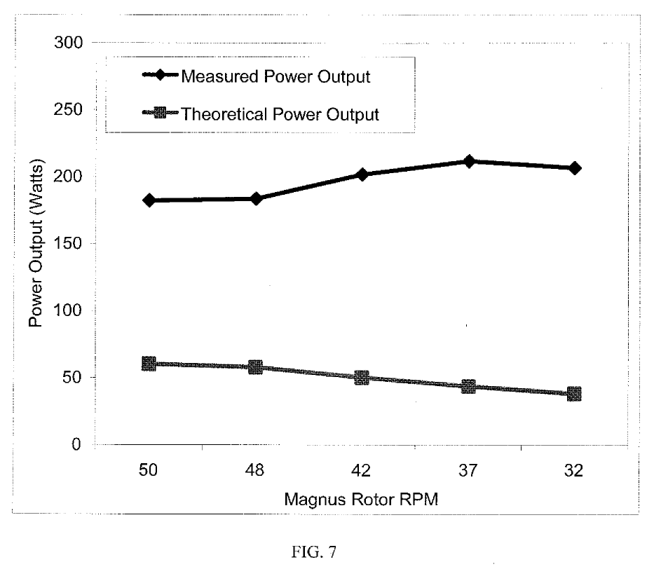

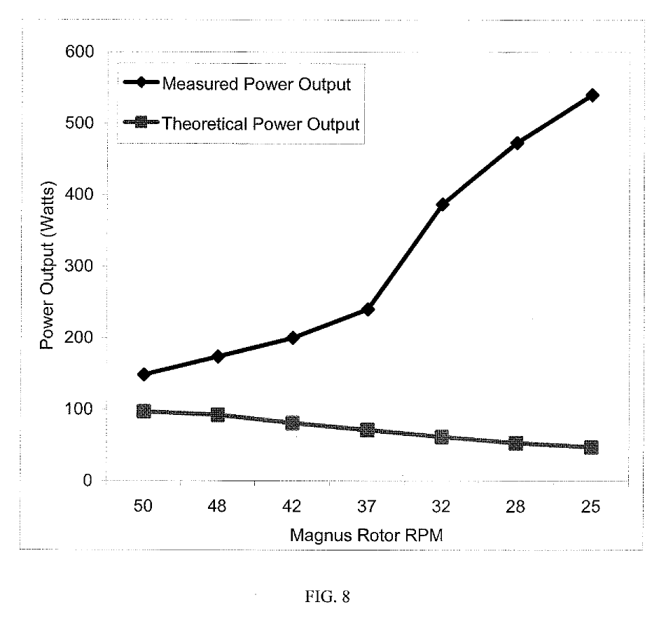

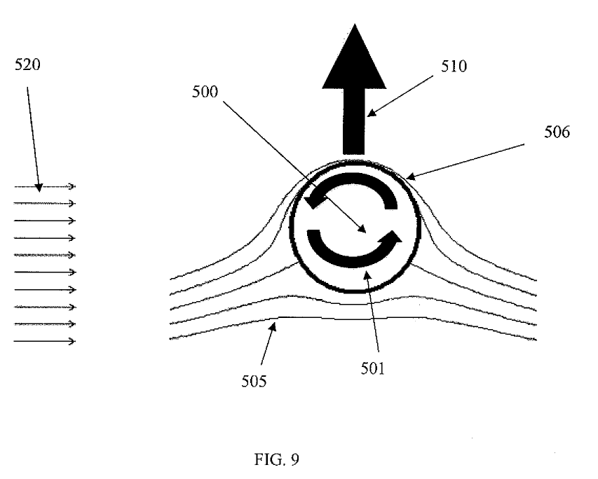

An energy harvester for use in fluid flows according to the present invention is shown in FIGS. 1, 2 and 3 and is mounted to a structure where the energy harvester is in communication with a fluid flow 90. The energy harvester comprises inflow fluid channel walls 4, 5, 6 and 7, energy harvester channel side walls 8, 9, 10, and 11 that receive a flow 90 from the fluid inflow channel walls 4, 5, 6 and 7. A main shaft 40 is located within a channel 95 defined by the inflow fluid channel walls 4, 5, 6, and 7 and the channel side walls 8, 9, 10, and 11 in which the fluid flow 90 is received. Magnus cylinders 200, 201, 210, and 211 are each mounted on a respective central axis 205 between the main shaft 40 and channel side walls 8, 9, 10 and 11. The walls can also be replaced with a tube 307 as shown in FIG. 4 and FIG. 5. The fluid flow path is defined by an inflow fluid channel formed by inflow fluid channel walls 4, 5, 6 and 7, an outflow fluid channel formed by channel side walls 8, 9, 10 and 11, and an energy harvester chamber 12 disposed between the inflow fluid channel and the outflow fluid channel and formed from channel side walls 8, 9, 10 and 11. The walls can also be curved either in the side or bottom walls in this configuration and have opposite elevations in the plane parallel to the fluid flow path. This acts as a concentrator for the fluid flow by channeling a greater volume of fluid to the energy harvester thereby increasing the speed of the fluid that will increase the lift generated by the cylinder. This intensification can be used in any of the embodiments envisioned by the present invention. It is also seen in the data presented in FIGS. 7 and 8. This data shows a significant improvement in torque from the theoretical to the actual. This is due to the amplification of the lift as the fluid is accelerated as it passes the first Magnus cylinder 200 and then moves down the next Magnus cylinder 201 where it is accelerated again and then moves down the next Magnus cylinder 210 and where it is accelerated again and then moves down the next Magnus cylinder 211. The Magnus force is developed as shown in FIG. 9. To increase the lift the energy harvester is replicated within 1-20 diameters of the Magnus cylinder. The fluid flow 90 can be hydraulic or pneumatic (air or gas).

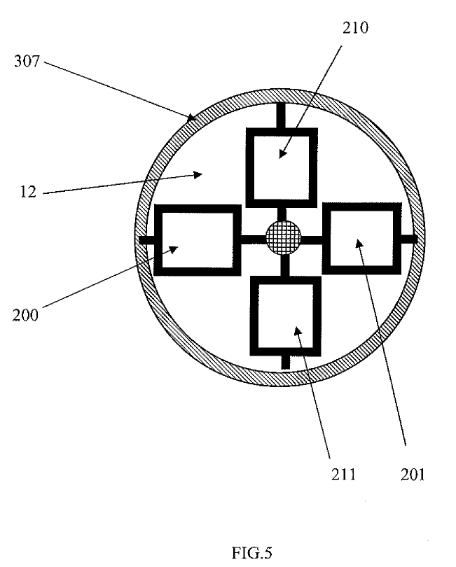

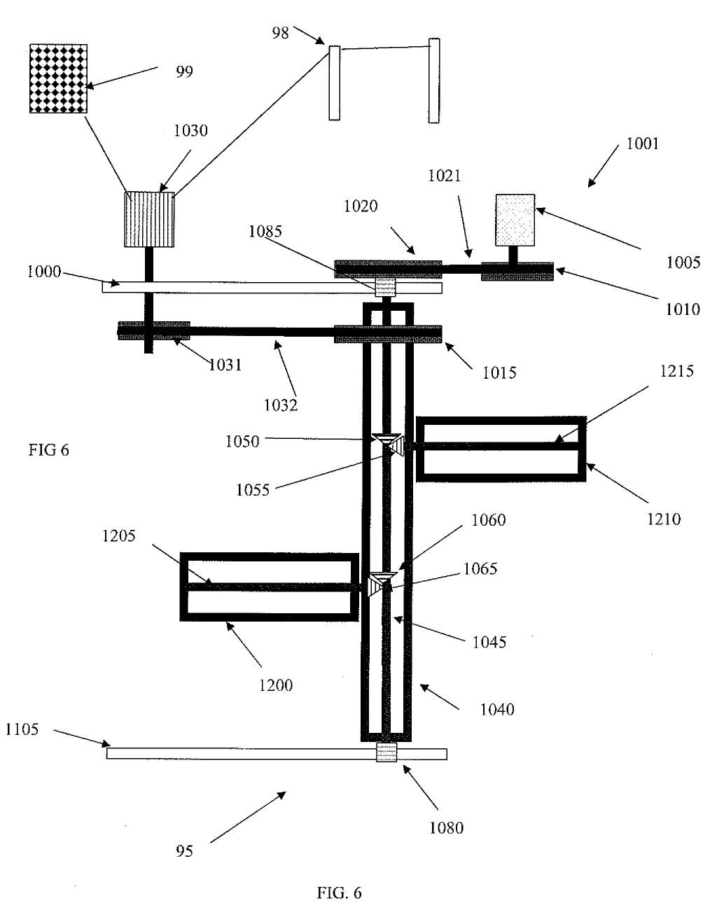

The cylinders are mounted inside a channel formed by a passage defined by the opposed channel side walls, an optional bottom chamber wall, the inflow fluid channel walls, and the outflow fluid channel walls. This passage directs the flow through the energy harvester. The cylinders are oriented transversely to the flow through the passage and are mounted for rotation, for example, via bearings 1080 and 1085 in cylinder supports 1000 and 1105 shown in FIG. 6.

The cylinders are rotated by a drive mechanism as shown in FIG. 6. The lift is generated via the Magnus effect when the flow is concentrated through the channel 95 and past the cylinders 200, 201, 210 and 211. The flow through the channel 95 and past the cylinders 200, 201, 210, and 211 forces the mechanism to rotate the main shaft 40 mechanism causing the drive mechanism to rotate generator 1030. This concentrating of fluid in the channel accelerates the flow by funneling the fluid towards the cylinders 200, 201, 210, and 211. However, the acceleration is unexpectedly amplified by the Magnus cylinders themselves and causes increased lift due to the acceleration of the fluid in the energy harvester chamber 12, thereby increasing the lift. The flow is further accelerated by each cylinder to increase the lift for the successively-positioned cylinders in the flow path. The diameters of the cylinder 200, 201, 210, and 211 may be the same, or they may vary relative to each other.

Therefore the performance of the radial Magnus turbine is improved by staggering the Magnus cylinders along the central shaft so that the each cylinder is in a separate plane as shown in FIGS. 1, 2, 3, 4, and 5. The fluid flow 90 can be hydraulic or pneumatic (air or gas).

FIGS. 4 and 5 show a rotational system that uses the fluid flow in the channel to rotate the cylinders in perpendicular fashion to develop lift perpendicular to the flow. The energy harvester chamber is a pipe 307. The design makes the device well suited for in-pipe operation. The round pipe shape further increases the torque created by the lift of the cylinders by keeping the fluid contained in a focused energy harvester chamber 12. The increase in torque is due to the increase in speed of the water due to the acceleration of the water around the Magnus cylinder and then interacting with the Magnus cylinder in a positive manner thereby generating higher lift forces. To increase the lift, the energy harvester is replicated within 2-20 diameters of the Magnus cylinder in the down stream direction of the flow. The fluid flow 90 can be hydraulic or pneumatic (air or gas).

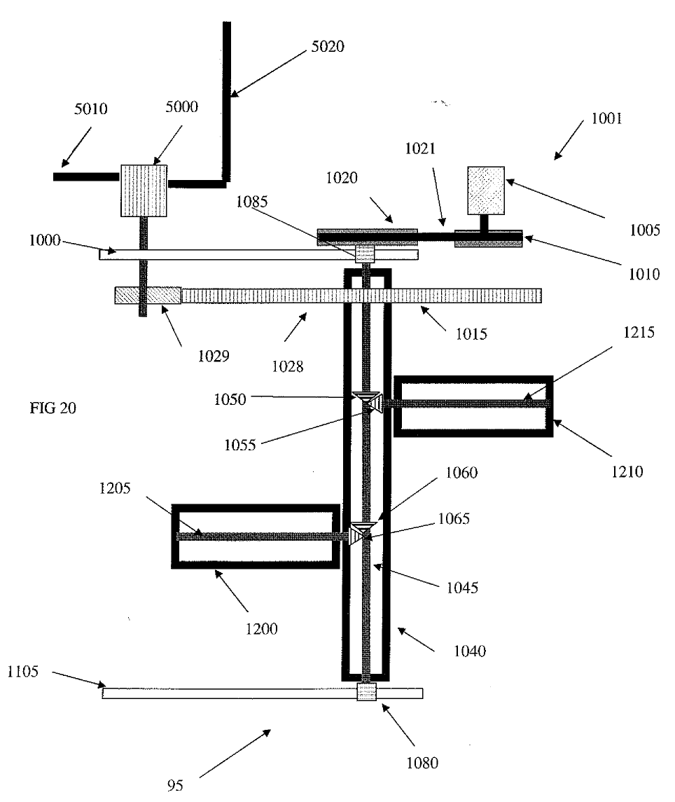

FIG. 6 shows the double shaft that transmits torque to drive the Magnus cylinders, the rotations of which in turn drive the outer shaft to drive the generator. A motor 1005 is connected to pulley 1010. A belt 1021 transmits torque from pulley 1010 to pulley 1020 to drive shaft 1045 supported in bearings 1085 and 1080. Driving the shaft 1045 drives the central axes 1205 and 1215, thereby causing Magnus cylinders 1200 and 1210 to rotate. This creates lift when subjected to flow 90 as shown in FIGS. 4 and 5. This lift then causes the outer shaft 1040 to rotate which drives the drive pulley 1015 to drive generator drive pulley 1031 (via belt 1032) to drive the generator 1030. A pinion gear 1029 or bull gear 1028 may be used to drive the generator 1030 as shown in FIG. 19. Generator 1030 can be attached to battery 99 or to electrical grid 98. The motor 1005 can be operable under electric, pneumatic, or hydraulic power and reversible to allow the rotation of the central shaft 40 to be the same direction if the flow 90 is reversed. The generator 1030 can be replaced with a pump 5000 as shown in FIG. 20 to pump fluids such as air or water. The pump 5000 input for the fluid is 5010 and the output from the pump 5000 is 5020. The fluid pumped can be a gas like air or a liquid like water.

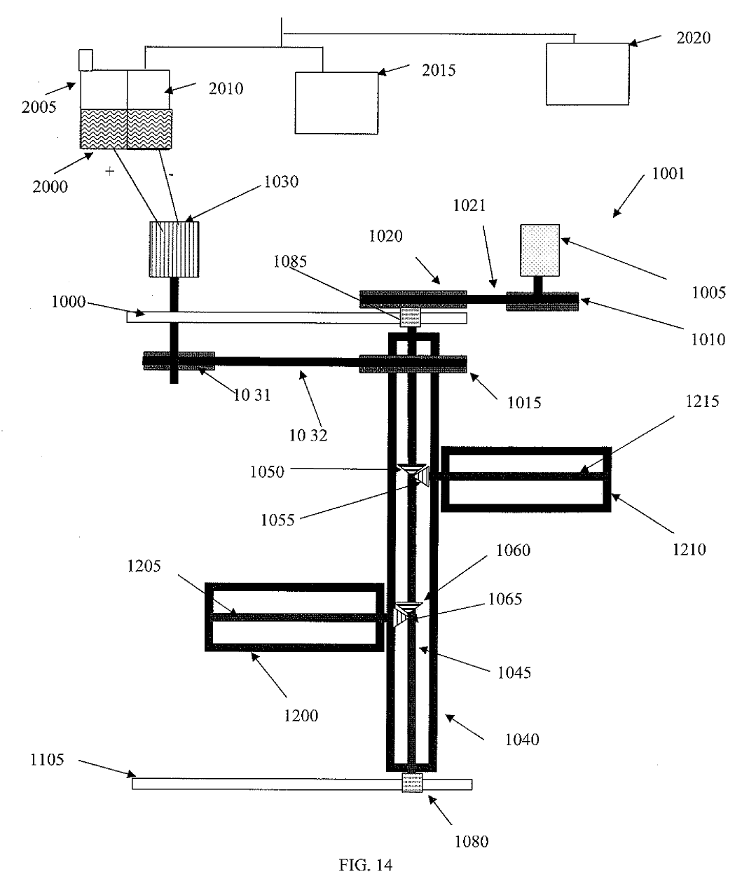

At least two sets of bevel gears 1050 and 1060 are located on shaft 1045 to drive the two Magnus cylinders (e.g., cylinder 1200 and cylinder 1210 attached to the central axes 1205 and 1215). Bevel gear 1055 is attached to shaft 1215 that is positioned to be in communication with bevel gear 1050 and bevel gear 1065 is attached to central axis 1205 which is positioned to be in communication with bevel gear 1060. The rotary motion of the motor 1005 drives the rotation of the Magus cylinders through the series of bevel gears. If more power is needed then additional Magnus cylinders can be added in pairs. The belts 1021 and 1032 can be replaced with roller chain, cogged belt, v-belt, ribbed belt, or cable. Alternatively referring to FIG. 14, the electricity from the generator 1030 can be used in a reaction chamber 2000 for separating water into oxygen and hydrogen using the electrical current, thereby breaking water into an outflow means for the oxygen 2005 and an outflow means for the hydrogen 2010. The hydrogen can then be stored in a pressurized bottle 2015 or oxidized directly in a conventional generator 2020.

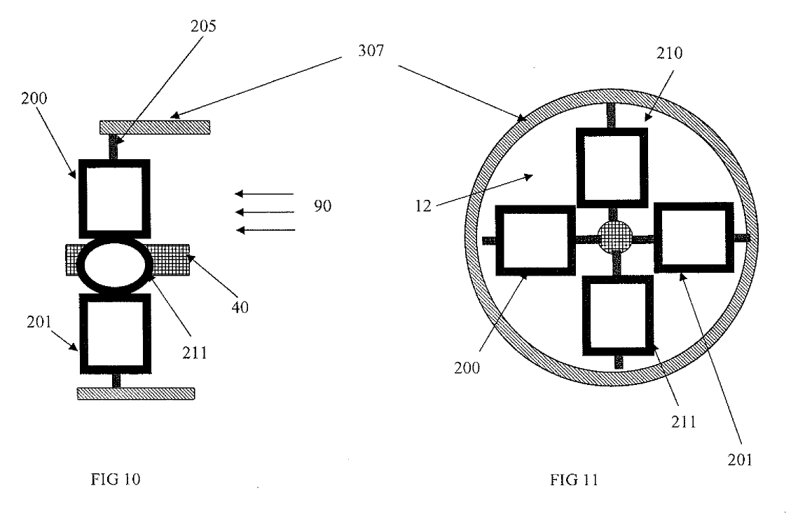

FIG. 9 shows a planar embodiment of an on-axis Magnus system. When the fluid flow 520 reaches the Magnus cylinder 500 which is rotating in direction 501, the flow is diverted around the cylinder causing higher pressure in flow stream 505 and lower pressure in flow stream 506. The gradient of flow stream 505 and flow stream 506 results in lift 510. Referring now to FIGS. 10 and 11, the energy harvester using the on-axis Magnus system of FIG. 9 is mounted to a structure where the energy harvester is in communication with a fluid flow 90. The energy harvester comprises side walls 307 that receive a flow 90. The central shaft 40 with Magnus cylinders 200, 201, 210, and 211 located thereon is mounted between the channel side walls 307. The fluid flow path is defined by an inflow fluid channel formed by channel walls 307. The walls can also be curved either in the side or bottom walls in this configuration and can have opposite elevations in the plane parallel to the fluid flow path. This acts as a concentrator for the fluid flow by channeling a greater volume of fluid to the energy harvester thereby increasing the speed of the fluid that will increase the lift generated by the cylinder. This intensification can be used in any of the embodiments envisioned by the present invention.

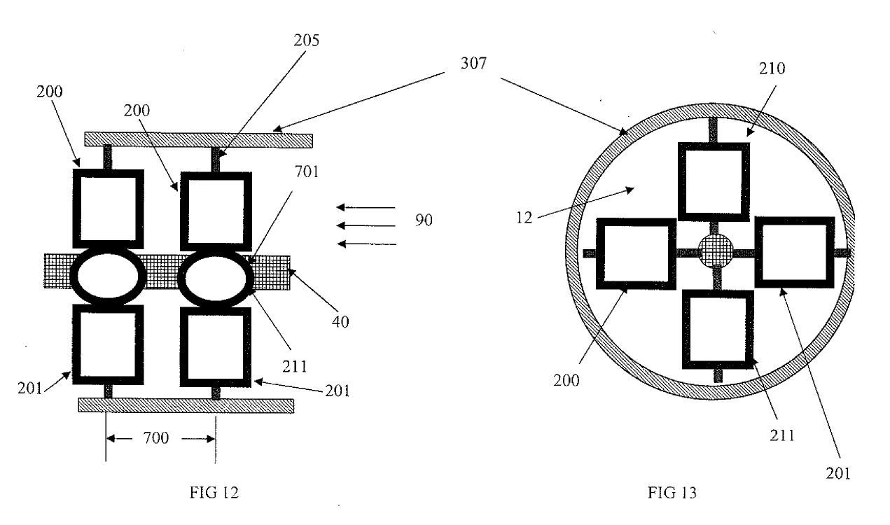

Referring now to FIGS. 12 and 13, Magnus cylinder diameters can be sized and arranged in tandem so that the Magnus cylinders in a second energy harvester benefit from the increase in water velocity caused by an initial energy harvester. Here the dimension 700 is equal to about 10 times the Magnus cylinder diameter 701. To increase the lift, the energy harvester is replicated within 1-20 diameters of the Magnus cylinder in the downstream direction of the flow. In any embodiment, the fluid flow 520 (FIG. 9) or 9 (FIGS. 10 and 11) can be hydraulic or pneumatic.

In any application, the fluid flows can be the output flow streams of an effluent system. For example, the inflow fluid channel can be connected to one or more of a sewer, a water treatment facility, a water drain, a holding pond, aqueducts, a roof drain, outflow from a dam, an air conditioning line, and a holding tank.

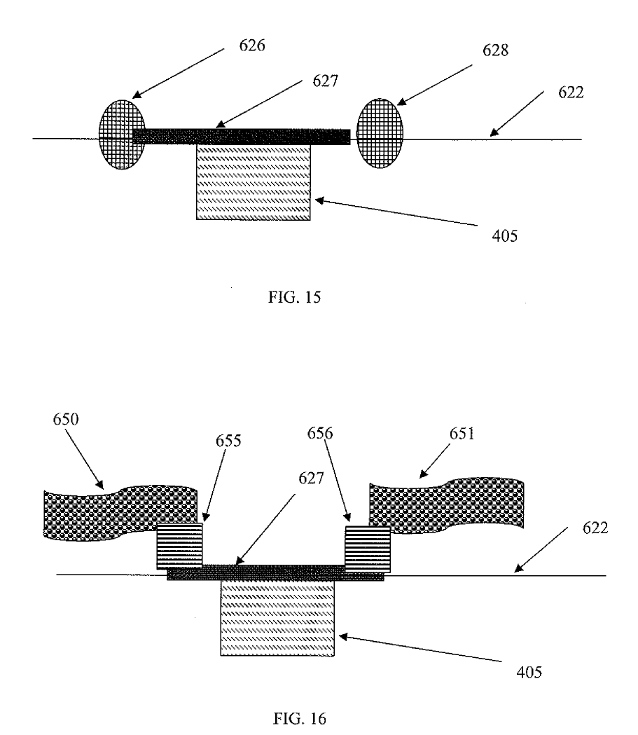

Referring to FIG. 15 an energy harvester 405 of the present invention is attached to a barge comprised of deck 627 and pontoons 626 and 628. The water line is shown as 622.

Referring to FIG. 16 an energy harvester 405 of the present invention is attached to a bridge structure comprised of deck 627, 650, 655, 656, and 651. The water line is shown as 622.

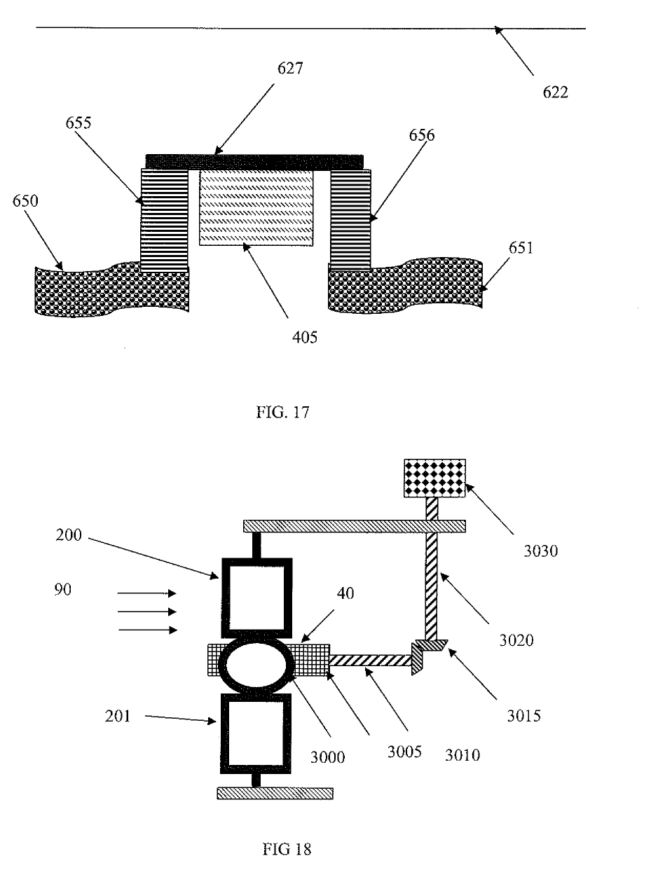

Referring to FIG. 17, an energy harvester 405 of the present invention is attached to a bottom of the fluid channel by deck 627 and pontoons 626 and 628. The water line is shown as 622.

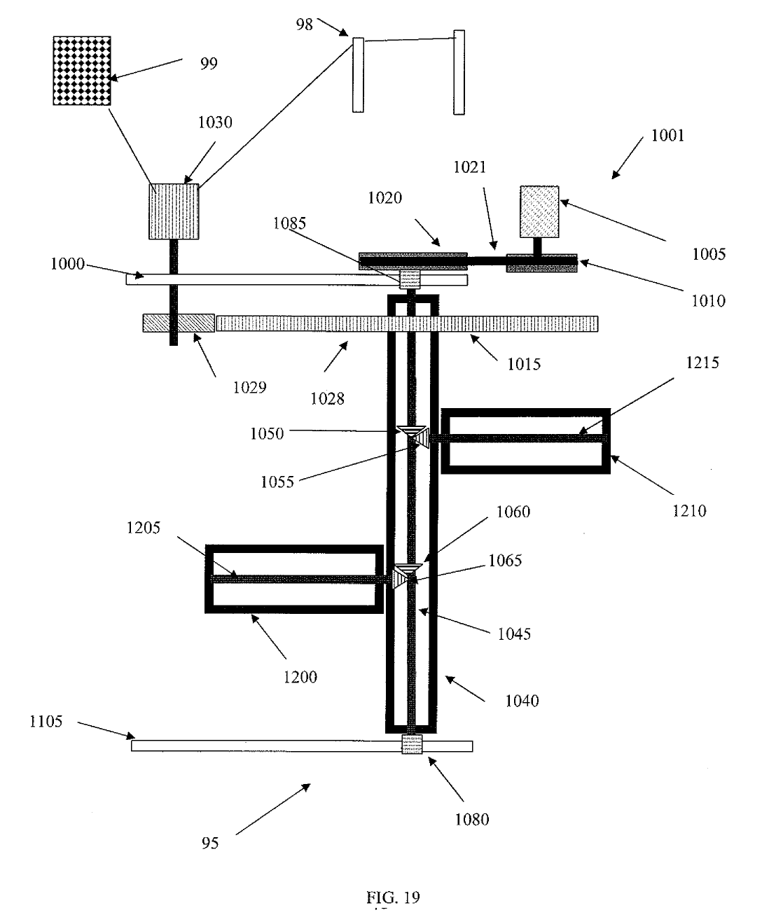

Referring to FIG. 18, an energy harvester 3000 of the present invention having shaft 40 is connected to a generator 3030 with shaft 3005, gears 3010 and 3015, and shaft 3020 instead of a belt drive system as shown in FIG. 6.

Energy harvester 405 can also be connected directly to a device such as a sensor to provide power for the sensor. Typical applications include weather sensors, wave sensors, and under water current sensors.

The energy harvester can be attached to either a floating platform or a fixed platform depending on the conditions of the fluid that it is placed in.

Although this invention has been shown and described with respect to the detailed embodiments thereof, it will be understood by those skilled in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. An energy harvester, comprising:
a fluid flow path defined by an inflow fluid channel, an outflow fluid channel, and a chamber disposed between said inflow fluid channel and said outflow channel;
a main shaft located in said chamber and axially positioned in said fluid flow path;
a first Magnus cylinder mounted transversely in said fluid flow path on said main shaft located in said chamber, said first Magnus cylinder being mounted on said main shaft by a first central axis and rotationally driven about said first central axis by a motor;
a second Magnus cylinder cooperatively associated with said first Magnus cylinder and mounted on said main shaft by a second central axis, said second Magnus cylinder being separated by a distance in a downstream direction of said fluid flow path and rotationally driven on said second central axis by said motor;
a means for producing an electrical current from a movement of said main shaft caused at least in part by a movement of said first Magnus cylinder and said second Magnus cylinder, said movement of said main shaft being in a direction perpendicular to said fluid flow path and providing a torque value that is greater than a theoretical torque value due to an acceleration of a fluid moving in said downstream direction of said fluid flow path, said acceleration being caused by a rotation of at least one of said first Magnus cylinder and said second Magnus cylinder;
a battery for charging by said electrical current produced from said means for producing said electrical current; and
means for connecting said battery to an electrical grid.

2. The energy harvester of claim 1, wherein said distance separating said second Magnus cylinder from said first Magnus cylinder is about 2 to about 20 diameters of said first Magnus cylinder in the downstream direction.

3. The energy harvester of claim 1, wherein said motor is operable under electric power.

4. The energy harvester of claim 1, wherein said motor is operable under pneumatic power.

5. The energy harvester of claim 1, wherein said motor is operable under hydraulic power.

6. The energy harvester of claim 1, wherein said energy harvester is attached to a floating platform.

7. The energy harvester of claim 1, wherein said energy harvester is attached to a non floating platform.

8. The energy harvester of claim 1 wherein a fluid in said fluid flow path is air.

9. The energy harvester of claim 1 wherein a fluid in said fluid flow path is water.

10. The energy harvester of claim 1 where said motor rotationally driving the Magnus cylinder rotates said Magnus cylinder in one direction for a positive flow and in an opposite direction for a negative flow.

11. The energy harvester of claim 1, wherein said means for producing said electrical current comprises:
a belt rotatably movable in response to movement of at least one of said first Magnus cylinder and said second Magnus cylinder, and
at least one pinion gear drivable by the movement of said belt, said pinion gear being operable connected to an electrical generator,
wherein driving of said pinion gear operable connected to an electrical generator produces said electrical current.

12. The energy harvester of claim 11, wherein said belt is selected from the group consisting of v-belts, ribbed belts, cogged belts, roller chain, and cables.

13. The energy harvester of claim 1, wherein at least two Magnus cylinders are positioned in said fluid flow path, said at least two Magnus cylinders being separated from each other by a minimum distance of 1 diameter of the largest Magnus cylinder.

14. The energy harvester of claim 1, wherein at least two Magnus cylinders are positioned in said fluid flow path, said at least two Magnus cylinders being separated by a maximum distance of 20 diameters of the largest Magnus cylinder.

15. An energy harvesting system for use in a fluid flow path, said energy harvesting system comprising:
a source of fluid;
a fluid flow path from said source of fluid and defined by an inflow fluid channel, an outflow fluid channel, and an energy harvester chamber disposed between said inflow fluid channel and said outflow fluid channel;
a first Magnus cylinder mounted in said energy harvester chamber transversely to said fluid flow path;
a second Magus cylinder cooperatively associated with said first Magnus cylinder located in a downstream direction from the first Magnus cylinder;
means for producing an electrical current from a movement of said first Magnus cylinder and said second Magnus cylinder, said movement of said first Magnus cylinder and said second Magnus cylinder being perpendicular to said fluid flow path and providing a torque value that is greater than a theoretical torque value due to an acceleration of a fluid flow in said downstream direction, said acceleration being caused by a rotation of at least one of said first Magnus cylinder and said second Magnus cylinder; and
means for connecting said means for producing said electrical current to an electrical power grid.

16. The energy harvesting system of claim 15, wherein said source of fluid is an effluent system.

17. The energy harvesting system of claim 15, wherein said source of fluid is a gas.

18. The energy harvesting system of claim 15 where the inflow fluid channel is connected to one or more of a sewer, a water treatment facility, a water drain, a holding pond, an aqueduct, a roof drain, an outflow from a dam, an air conditioning line, and a holding tank.

19. The energy harvester of claim 1, wherein a fluid in said fluid flow path is received from an effluent system.

20. The energy harvester of claim 1, wherein a fluid in said fluid flow path is a gas.

21. The energy harvester of claim 1 where the inflow fluid channel is connected to one or more of a sewer, a water treatment facility, a water drain, a holding pond, a roof drain, an air conditioning line, and a holding tank.

22. An energy harvesting system for use in a fluid flow application, said energy harvesting system comprising:
a source of fluid;
an outflow line extending from said source of fluid;
a fluid flow path in said outflow line and defined by an inflow fluid channel, an outflow fluid channel, and an energy harvester chamber disposed between said inflow fluid channel and said outflow fluid channel;
a first Magnus cylinder mounted in said energy harvester chamber transverse to a flow of fluid in said fluid flow path;
at least a second Magus cylinder downstream from said first Magnus cylinder and cooperatively associated with said first Magnus cylinder;
means for producing an electrical current from a movement of said first Magnus cylinder and said second Magnus cylinder in a direction perpendicular to said fluid flow path and providing a torque value that is greater than a theoretical torque value due to an acceleration of said flow of fluid in a downstream direction of said fluid flow path, said acceleration being caused by a rotation of at least one of said first Magnus cylinder and said second Magnus cylinder;
a reaction chamber for separating water into oxygen and hydrogen using said electrical current;
an outflow means for the oxygen; and
an outflow means for the hydrogen.

23. An energy harvesting system for use in a fluid flow application, said energy harvesting system comprising:
a source of fluid;
a floating platform located in fluid communication with said source of fluid;
an outflow line extending from said source of fluid;
a fluid flow path in said outflow line and defined by an inflow fluid channel, an outflow fluid channel, and an energy harvester chamber disposed between said inflow fluid channel and said outflow fluid channel;
a first Magnus cylinder transversely mounted in said energy harvester chamber and retractably movable parallel to a flow of fluid in said fluid flow path;
at least a second Magus cylinder cooperatively associated with said first Magnus cylinder and retractably movable parallel to said flow of fluid in said fluid flow path;
means for producing an electrical current from a movement of said first Magnus cylinder and said second Magnus cylinder perpendicular to said flow of fluid in said fluid flow path and providing a torque value that is greater than a theoretical torque value due to an acceleration of said flow of fluid in a downstream direction of said fluid flow path, said acceleration being caused by a rotation of at least one of said first Magnus cylinder and said second Magnus cylinder; and
means for connecting the means for producing the electrical current to an electrical grid.

24. An energy harvesting system for use in a fluid flow, said energy harvesting system comprising:
a bridge platform;
a source of fluid;
an outflow line extending from said source of fluid;
a fluid flow path in said outflow line and defined by an inflow fluid channel, an outflow fluid channel, and an energy harvester chamber disposed between said inflow fluid channel and said outflow fluid channel;
a first Magnus cylinder transversely mounted in said energy harvester chamber and retractably movable parallel to a flow of fluid in said fluid flow path;
at least a second Magus cylinder cooperatively associated with said first Magnus cylinder;
means for producing an electrical current from a movement of at least said first Magnus cylinder in said fluid flow path perpendicular to said flow of fluid in said fluid flow path, said movement providing a torque value that is greater than a theoretical torque value due to an acceleration of said flow of fluid moving in a downstream direction of said fluid flow path, said acceleration being caused by a rotation of at least one of said first Magnus cylinder and said second Magnus cylinder; and
means for connecting the means for producing the electrical current to an electrical grid.

25. The energy harvester of claim 23, wherein the electrical generator produces said electrical current and is connected directly to the power grid.

26. An energy harvesting system for use in a fluid flow application, said energy harvesting system comprising:
a bridge platform;
a source of fluid;
an outflow line extending from said source of fluid;
a fluid flow path in said outflow line and defined by an inflow fluid channel, an outflow fluid channel, and an energy harvester chamber disposed between said inflow fluid channel and said outflow fluid channel;
a first Magnus cylinder transversely mounted in said energy harvester chamber and retractably movable parallel to the flow of fluid;
at least a second Magus cylinder located in a downstream direction at least 2 diameters of the first Magnus cylinder from said first Magnus cylinder and cooperatively associated with said first Magnus cylinder; and
means for producing an electrical current from a movement of at least said first Magnus cylinder in said fluid flow path in a direction perpendicular to said fluid flow path, said movement providing a torque value that is greater than a theoretical torque value due to an acceleration of a fluid moving in said downstream direction of said fluid flow path, said acceleration being caused by a rotation of at least one of said first Magnus cylinder and said second Magnus cylinder.

27. The energy harvester of claim 1, wherein said means for producing said electrical current comprises:
a drive shaft rotate ably movable in response to movement of at least said first Magnus cylinder, and
at least one gear drivable by the movement of at least said first Magnus cylinder, said gear being operably connected to an electrical generator,
wherein driving of said gear operably connected to an electrical generator produces said electrical current.

28. An energy harvester, comprising:
a first drive shaft;
means to rotate said first drive shaft;
a first Magnus cylinder connected to said first drive shaft for driving said first Magnus cylinder;
a second Magnus cylinder located downstream from the first Magnus cylinder and connected to said first drive shaft for associated operability with the first Magnus cylinder;
a fluid in communication with said first and second Magnus cylinders;
a second drive shaft rotatably movable in response to movement of said first Magnus cylinder and said second Magnus cylinder, and
at least one gear drivable by the movement of at least said second drive shaft, said gear being operable connected to an electrical generator,
wherein driving of said gear operable connected to an electrical generator produces said electrical current.

29. The energy harvester of claim 28, wherein second Magnus cylinder is separated by 2 to 20 diameters of the diameter of said first Magnus cylinder in the downstream direction.

30. The energy harvester of claim 28, wherein said means to rotate the first drive shaft is an electric motor.

31. The energy harvester of claim 28, wherein said means to rotate the first drive shaft is a pneumatic motor.

32. The energy harvester of claim 28, wherein said means to rotate the first drive shaft is a hydraulic motor.

33. The energy harvester of claim 28, wherein said energy harvester is attached to a floating platform.

34. The energy harvester of claim 28, wherein said energy harvester is attached to a non floating platform.

35. The energy harvester of claim 28 wherein said fluid is air.

36. The energy harvester of claim 28 wherein said fluid is water.

37. The energy harvester of claim 28 wherein said means to rotate said first drive shaft rotates said first Magnus cylinder in one direction for a flow of said fluid in one direction and in a reverse direction for a flow of said fluid in an opposite direction.

38. A device for energy harvesting, comprising:
a first drive shaft;
means to rotate said first drive shaft;
a first Magnus cylinder connected to said first drive shaft and rotatable by said first drive shaft;
a second Magnus cylinder located downstream from the first Magnus cylinder at least 2 diameters of the first Magnus cylinder from the first Magnus cylinder and connected to said first drive shaft for associated operability with the first Magnus cylinder;
a fluid in communication with said first and second Magnus cylinders;
a second drive shaft rotatably movable in response to movement of said first Magnus cylinder and said second Magnus cylinder, and
at least one gear drivable by the movement of at least said second drive shaft, said gear being operably connected to an electrical generator,
wherein a torque produced by the driving of said gear operably connected to said electrical generator produces said electrical current; and
wherein said torque is greater than a theoretical torque value due to an acceleration of said fluid moving in a downstream direction, said acceleration being caused by a rotation of at least one of said first Magnus cylinder and said second Magnus cylinder.

39. A device for energy harvesting, comprising:
a first drive shaft;
means to rotate said first drive shaft;
a first Magnus cylinder connected to said first drive shaft and rotatable by said first drive shaft;
a second Magnus cylinder located downstream from the first Magnus cylinder at least 2 diameters of the first Magnus cylinder from the first Magnus cylinder and connected to said first drive shaft for associated operability with the first Magnus cylinder;
a first fluid in communication with said first and second Magnus cylinders;
a second drive shaft rotatably movable in response to movement of said first Magnus cylinder and said second Magnus cylinder in said first fluid, and
at least one gear drivable by the movement of at least said second drive shaft, said gear being operably connected to a pump,
wherein a torque produced by the driving of said gear operably connected to the pump pumps a second fluid; and
wherein said torque is greater than a theoretical torque value due to an acceleration of said first fluid moving in a downstream direction, said acceleration being caused by a rotation of at least one of said first Magnus cylinder and said second Magnus cylinder.

40. The energy harvesting system of claim 26, wherein a distance separating the first Magnus cylinder and the second Magnus cylinder is from 2 to 20 diameters of the first Magnus cylinder.

41. The device of claim 38, wherein a distance separating the first Magnus cylinder and the second Magnus cylinder is from 2 to 20 diameters of the first Magnus cylinder.

42. The device of claim 39, wherein a distance separating the first Magnus cylinder and the second Magnus cylinder is from 2 to 20 diameters of the first Magnus cylinder.
